(19) United States
(12) Patent Application Publication
(10) Pub. No.: US 2003/0042727 A1
(43) Pub. Date: Mar. 6, 2003

(54) Method and apparatus for moving furniture

(76) Inventor: Ajit Khubani, Saddle River, NJ (US)

Correspondence Address: Cooper & Dunham LLP, 1185 Avenue of the Americas, New York, NY, 10036, US

(21) Appl. No.: 09/947,173

(22) Filed: Sep. 5, 2001

(51) Int. Cl. A62B 9/04

(52) U.S. Cl. 280/845; 280/28.17

(57) ABSTRACT

A furniture moving device including a circular sliding section made of substantially friction-free material with a lip formed at a periphery of the circular sliding section and a support section made of a substantially compressible material fixedly attached at a position substantially centered on the circular sliding section. The support section supports a ground contact of furniture, such as a leg or edge, so that the ground contact does not slide with respect to the support section. When force is applied to the furniture, the ground contact of the furniture remains in contact with the support section and moves along with the circular sliding section as the circular sliding section slides along the surface in the direction in which the force is applied.

### FIELD OF THE DISCLOSURE

The present disclosure relates to an object moving device. More specifically, to a furniture moving device including a circular sliding section and a compressible support section fixedly attached to a top of the circular sliding section.

### BACKGROUND OF THE ART

Moving large pieces of furniture is often a difficult and strenuous task. Even where the furniture is not particularly heavy, the size of the furniture often makes it awkward to maneuver with any precision.

Devices have been introduced to aid in moving pieces of furniture. These traditional devices are typically designed to be placed under a leg or edge of a piece of furniture so that the furniture will slide over a surface without the furniture needing to be lifted.

U.S. Pat. No. 5,984,360 to Edwards et al., for example, relates to a furniture slide for placement between an object to be moved and the flooring over which the object is to be moved. The slide is formed from an elongated sheet of flexible material having opposing ends and side walls joining the opposing ends when viewed in plan. The sheet has opposing faces when viewed in side with one of the faces for abutting support and sliding contact with a floor surface and the other face having a compressible material fixed thereon for an abutting support contact with an object to be moved.

This type of a traditional furniture moving device, however, has a few problems. When the surface of the device contacting the floor has an edge that is flat, the furniture moving device can be difficult to slide over certain surfaces, such as a thick carpet. For example, the weight of the furniture may press the device into the carpet such that fibers of the carpet extend above the edge of the device. In this case, the edge will contact the side of the fibers generating resistance so that sliding the furniture is more difficult.

Another problem that can arise from the resistance is the furniture slipping off the moving device. U.S. Pat. No. 5,220,705 to Bushey addresses the problem by providing on adhesive to attach to the furniture. However, such an adhesive prevents easy removal from the furniture and subsequent re-use of the moving device.

In addition, in a moving device where the compressible material contacting the furniture does not extend above the edge of the bottom section of the moving device, certain difficulties arise. For example, if such a device were used to move a chest or trunk with no legs, the edge of the bottom of the chest would rest on the edge of the bottom section. The weight of the chest on the bottom section would cause the sliding section to bend and deform thereby creating an irregular shape which increases resistance. In addition, since the bottom section is commonly made of a low friction material to aid in sliding, the chest would likely slide off of the edge of the moving device since the edge of the chest would not be held fast by the compressible material when force is applied to move the chest.

Also, an elongated device such as that proposed by Edwards is more difficult to manufacture, with respect to the placement of the compressible material. Because the compressible material is preferably positioned roughly in the center of the device, a worker can encounter difficulty in properly positioning the compressible material.

Thus, providing a furniture moving device that firmly engages the furniture to be moved and which is easily manufactured is desirable.

### SUMMARY OF THE DISCLOSURE

An object moving device includes a circular sliding section made of a substantially friction-free material and including a lip formed at a periphery of the circular sliding section and a support section made of a compressible material fixedly attached to the circular sliding section substantially centered on the circular sliding section such that a space is left between a periphery of the support section and the lip of the circular sliding section with the support section extending above the lip of the circular sliding section. At least a portion of the support section compresses when a ground contact of an object is placed on top of the support section such that the support section engages the ground contact of the object to resist sliding movement between the ground contact and the support section. When a force is applied to the object, the object, the support section, and the circular sliding section slide together along a surface.

The the circular sliding section can be made of a low-friction elastic plastic. The circular sliding section can include a substantially flat bottom surface. The circular sliding section can include a convex bottom surface.

The support section can be made of a substantially elastic material such that a shape of the support section remains substantially unchanged after use of the furniture moving device.

A method of moving an object includes placing at least one object moving device on a surface over which the object is to be moved; placing a ground contact of the object on a support section of the at least one furniture moving device, wherein the support section extends above a height of a lip formed at a periphery of a circular sliding section of the object moving device and at least a portion of the support section compresses under a weight of the object and engages the ground contact of the object such that the ground contact does not slide on the support section; applying a force to the object such that the object, the support section, and the circular sliding section, to which the support section is fixedly attached in a position substantially centered on the circular sliding section, with a space left between a periphery of the support section and the lip of the circular sliding section, slide together along the surface; and removing the ground contact from the support section after the furniture is moved.

The circular sliding section can be made of a low-friction, elastic plastic. The circular sliding section can include a substantially flat bottom surface. The circular sliding section can include a convex bottom surface.

The support section can be made of a substantially elastic material such that the shape of the support section remains substantially the same after use of the furniture moving device.

### BRIEF DESCRIPTION OF THE DRAWINGS

FIG. 1 is an illustration of a sectional perspective view of a furniture moving device according to an embodiment of the present invention;

FIG. 2 is an illustration of a sectional perspective view of a circular sliding section of a furniture moving device according to an embodiment of the present invention;

FIG. 3 is an illustration of a sectional perspective view of a circular sliding section of a furniture moving device according to another embodiment of the present invention;

FIG. 4 is an illustration of a sectional perspective of a support section of a furniture moving device according to an embodiment of the present invention; and

FIG. 5 is a flow chart illustrating a method of moving furniture according to an embodiment of the present invention.

### DETAILED DESCRIPTION OF THE PREFERRED EMBODIMENT

The present disclosure relates to an object moving device. More specifically, the present disclosure relates to a furniture moving device including: (1) a circular sliding section with a lip formed at a periphery of the circular sliding section; and (2) a support section fixedly attached to the circular sliding section substantially at the center of the circular sliding section and extending above the lip of the circular sliding section made of a compressible material for supporting an object to be moved. The present invention is described in relation to moving furniture, thus the term furniture moving device is used. It should be understood, however, that the present invention can be used to move any object.

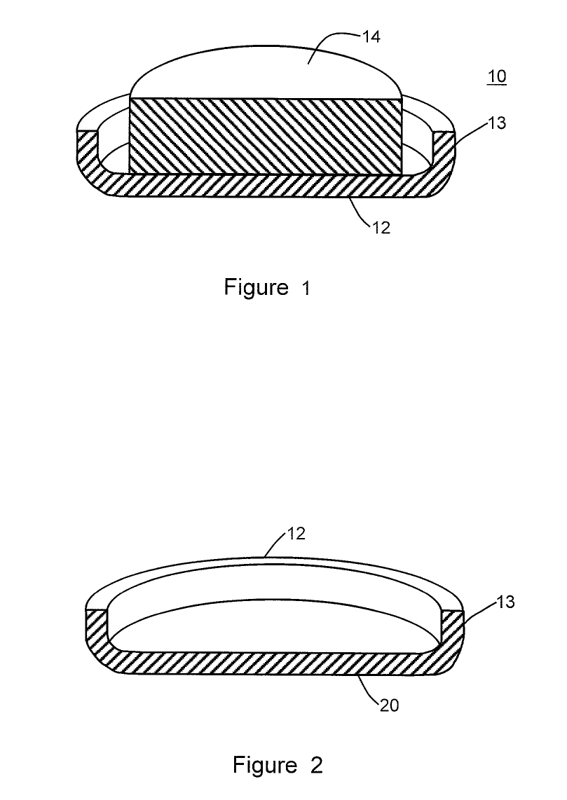

A furniture moving device 10 according to an embodiment of the present disclosure is illustrated generally in FIG. 1. The circular sliding section 12 is made of a substantially friction-free material such that the circular sliding section 12 slides along a surface under a piece of furniture with relative ease. The support section 14 is fixedly attached to the circular sliding section 12 and extends above a lip 13 formed at the periphery of the circular sliding section. The support section 14 can support a ground contact of a piece of furniture, such as a leg or edge, such that as force is applied to the furniture in a given direction, the ground contact remains in contact with the support section 14 and slides in the given direction with the furniture moving device 10.

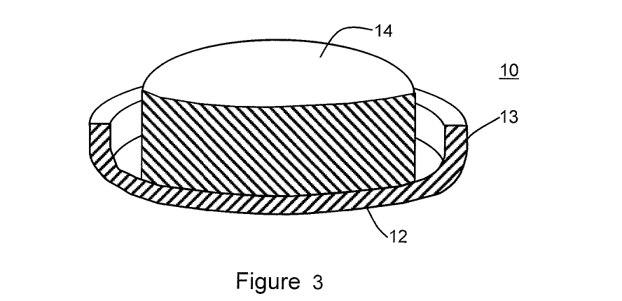

The circular sliding section 12 is described further with reference to FIG. 2. A bottom surface 20 of the circular sliding section 12 is shown as substantially flat in FIG. 2. The circular sliding section 12, however, can include a convex bottom surface (see FIG. 3). The bottom surface 20 aids in reducing friction between the circular sliding surface 12 and the ground surface. At least the bottom surface 20 is made of a material that has a low coefficient of friction, that is, a material that will slide easily along a surface such as a carpet or a smooth floor. The entire circular sliding section 12 can be made of the same material or a different material.

The lip 13 is formed along the periphery of the circular sliding surface 12 and extends upward. The lip 13 is particularly useful when the furniture moving device 10 is used on a surface such as a thick carpet. As noted above, when furniture is placed on top of traditional furniture moving devices, the weight of the furniture can press a bottom portion of the device down into the carpet. Thus, an edge of the bottom portion of the device may be lower than fibers of the carpet itself, which causes the edge to hit the sides of the carpet fibers as the object slides thereby increasing resistance. The lip 13 of the present invention provides for the smooth encounter of the fibers of the carpet with the furniture moving device 10. Therefore, the lip 13 is preferably of sufficient height, curvature and smoothness to prevent the lip edge from hitting the sides of the carpet fibers. The circular shape of the furniture moving device 10 provides for good mobility of the furniture moving device in all directions.

The circular sliding section 12, particularly the bottom surface 20 of the circular sliding section, should be made of a material with a relatively low coefficient of friction, as noted above. Preferably, the circular sliding section 12 is made of a durable plastic material that is somewhat elastic and thus able to support a large amount of weight without breaking. The material should also provide a strong bond to the support section 14 which will be described in more detail below.

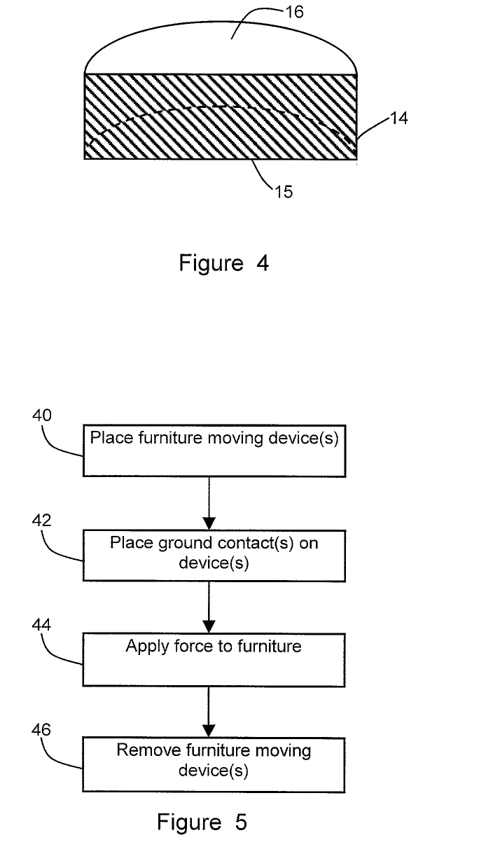

The support section 14 is described further with reference to FIG. 4. The support section 14 is preferably circular in shape like the circular sliding section 12. The support section 14 should be fixedly attached to the circular sliding section 12 in a substantially centered position. It should be noted that for manufacturing purposes, centering a circular support section on a circular sliding section is easier then centering other shapes such as the oblong shape of Edwards. A simple adhesive, such as glue, can be used to fix a bottom surface 15 of the support section 14 to the circular sliding section 12. The support section 14 should be made of a compressible material and should extend above the lip 13 of the circular sliding section 12. This feature allows a top surface 16 of the support section 14 to support the ground contact of the furniture even if the ground contact element is too large to fit within the periphery of the circular sliding section 12. For example, an edge of a piece of furniture such as chest or trunk that is too long to fit within the periphery of the circular sliding section 12 can be supported on the top surface 16 of support section 14 above the circular sliding section 12. The support section 14 is compressible and thus deforms slightly under the edge, while preventing the edge from resting on and deforming the circular sliding section 12. The top surface 16 of the support section 14 may be flat as shown in FIG. 4 or may be slightly concave.

The support section 14 should be made of a compressible and substantially elastic material such that the shape of the support section will remain substantially similar even after repeated use. The support section 14 should have a width that is less than that of the circular sliding section 12. The space between the periphery of the support section 14 and the lip 13 of the circular sliding section 12 allows room for the support section to expand outwardly as it is compressed down by the weight of the furniture supported thereon.

The support section 14 compresses slightly as the ground contact of the furniture is placed on the support section. A small depression may form in the top surface 16 of the support section 14 as the support section compresses. This small depression engages the ground contact of the furniture. The ground contact is thereby held securely on the support section 14 such that the ground contact moves with the support section rather than sliding off of the support section. Since the support section 14 is fixedly attached to the circular sliding section 12, as a force is applied to the furniture, the circular sliding section slides across the ground surface. The ground contact of the furniture remains engaged by the compressible support section 14 such that furniture stays fixed on top of the support section as the circular sliding section 12 slides across the ground surface.

Multiple furniture moving devices such as the furniture moving device 10 illustrated in FIG. 1 may be used to move the piece of furniture. For example, a furniture moving device may be placed under each ground contact, such as the four corners of a chest or trunk of the furniture to reduce friction and facilitate sliding of the furniture.

A method of moving furniture is described with reference to FIG. 5. At step 40, at least one furniture moving device such as the furniture moving device of FIG. 1 is placed on a ground surface over which furniture is to be moved. At step 42, a ground contact of the furniture, such as a leg or edge, is placed on a compressible support section of the at least one furniture moving device which extends above a lip of a circular sliding section of the furniture moving device. The support section compresses slightly under the weight of the furniture and engages the ground contact such that the ground contact does not slide on the support section. At step 44, a force is applied to the furniture in the desired direction of movement. The furniture moves in the direction of the force as the circular sliding section of the furniture moving device to which the support layer is fixedly attached slides along the ground under the furniture. At step 46, after the furniture has been moved, the at least one furniture moving device may be removed from under the ground contact of the furniture for future use.

The support section of the at least one furniture moving device in the above described method compresses downward under the weight of the furniture and can expand outward into a space between a periphery of the support section and a lip of the circular sliding section. The support section extends above the lip of the circular sliding section so that the ground contact of the furniture is supported by the support section and does not contact the lip of the circular sliding section.

Alternatively, in step 40 of the method of FIG. 5, a plurality of furniture moving devices may be placed on the ground surface over which furniture is to be moved. At step 42, a respective selected ground contact of the furniture is placed on each of the plurality of furniture moving devices. The operation of each of the plurality of ground contact devices is substantially as described above.

While the present application discloses specific embodiments of a furniture moving device, it should be understood that many variations are possible. The present application is intended to extend to all such variations permissible under the claims appended hereto.

What is claimed is:

1. An object moving device comprising:
a circular sliding section made of a substantially friction-free material and including a lip formed at a periphery of the circular sliding section; and
a support section made of a compressible material fixedly attached to the circular sliding section substantially centered on the circular sliding section such that a space is left between a periphery of the support section and the lip of the circular sliding section with the support section extending above the lip of the circular sliding section; wherein
at least a portion of the support section compresses when a ground contact of an object is placed on top of the support section such that the support section engages the ground contact of the object to resist sliding movement between the ground contact and the support section; and wherein
when a force is applied to the object, the object, the support section, and the circular sliding section slide together along a surface.

2. The object moving device of claim 1, wherein the circular sliding section comprises a low-friction elastic plastic.

3. The object moving device of claim 1, wherein the circular sliding section comprises a substantially flat bottom surface.

4. The object moving device of claim 1, wherein the circular sliding section comprises a convex bottom surface.

5. The object moving device of claim 1, wherein the support section comprises a substantially elastic material such that a shape of the support section remains substantially unchanged after use of the furniture moving device.

6. A method of moving an object comprising:
placing at least one object moving device on a surface over which the object is to be moved;
placing a ground contact of the object on a support section of the at least one furniture moving device, wherein the support section extends above a height of a lip formed at a periphery of a circular sliding section of the object moving device and at least a portion of the support section compresses under a weight of the object and engages the ground contact of the object such that the ground contact does not slide on the support section;
applying a force to the object such that the object, the support section, and the circular sliding section, to which the support section is fixedly attached in a position substantially centered on the circular sliding section, with a space left between a periphery of the support section and the lip of the circular sliding section, slide together along the surface; and
removing the ground contact from the support section after the furniture is moved.

7. The method of claim 6, wherein the circular sliding section comprises a low-friction, elastic plastic.

8. The method of claim 6, wherein the circular sliding section comprises a substantially flat bottom surface.

9. The method of claim 6, wherein the circular sliding section comprises a convex bottom surface.

10. The method of claim 6, wherein the support section comprises a substantially elastic material such that the shape of the support section remains substantially the same after use of the furniture moving device.
